(19) United States
(12) Patent Application Publication
(10) Pub. No.: US 2024/0329448 A1
(43) Pub. Date: Oct. 3, 2024

(54) DISPLAY MODULE AND DISPLAY APPARATUS

(71) Applicants: CHENGDU BOE OPTOELECTRONICS TECHNOLOGY CO., LTD., Chengdu, Sichuan (CN); BOE TECHNOLOGY GROUP CO., LTD., Beijing (CN)

(72) Inventors: Shengxing ZHANG, Beijing (CN); Liqiang CHEN, Beijing (CN); Jiafan SHI, Beijing (CN)

(21) Appl. No.: 18/246,044

(22) PCT Filed: May 26, 2022
(86) PCT No.: PCT/CN2022/095373

§ 371 Date: Jun. 25, 2024

(51) Int. Cl. G02F 1/1333; G06F 1/16; G09F 9/30

(52) U.S. Cl. CPC G02F 1/133305; G06F 1/1652; G09F 9/30; G02F 2203/01

(57) ABSTRACT

A display module includes a flexible display panel, a support plate, a transparent support structure and a light-shielding portion. The flexible display panel includes a display surface, and the display surface includes a light-transmissive region. The support plate is disposed on a side of the flexible display panel facing away from the display surface, and the support plate has a light-transmissive hole. The transparent support structure is filled in the light-transmissive hole, and an orthographic projection of the transparent support structure on the display surface at least partially overlaps with the light-transmissive region. The light-shielding portion disposed on at least part of a sidewall of the light-transmissive hole.

### CROSS-REFERENCE TO RELATED APPLICATION

This application is a national phase entry under 35 USC 371 of International Patent Application No. PCT/CN2022/095373, filed on May 26, 2022, which is incorporated herein by reference in its entirety.

### TECHNICAL FIELD

The present disclosure relates to the field of display technologies, and in particular, to a display module and a display apparatus.

### BACKGROUND

With the rapid development of display industries, various flexible display panels (such as curved display panels, foldable display panels, irregular-shaped display panels and rollable display panels) become popular in the market. The flexible display panel is generally made base on a flexible material, and a support member needs to be provided at a back of the flexible display panel to support the flexible display panel.

However, the support member is generally made of a non-light-transmissive material, which cannot meet cameras' requirements for light. Therefore, it greatly restricts the use of under-screen cameras.

### SUMMARY

In an aspect, a display module is provided. The display module includes a flexible display panel, a support plate, a transparent support structure and a light-shielding portion. The flexible display panel includes a display surface, and the display surface includes a light-transmissive region. The support plate is disposed on a side of the flexible display panel facing away from the display surface, and the support plate has a light-transmissive hole. The transparent support structure is filled in the light-transmissive hole, and an orthographic projection of the transparent support structure on the display surface at least partially overlaps with the light-transmissive region. The light-shielding portion disposed on at least part of a sidewall of the light-transmissive hole.

In some embodiments, the display module further includes a reflection-reducing layer. The reflection-reducing layer is located in the light-transmissive hole, the reflection-reducing layer and the transparent support structure are stacked.

In some embodiments, the reflection-reducing layer is located on a side of the transparent support structure proximate to the flexible display panel.

In some embodiments, the reflection-reducing layer includes at least two first refractive layers and at least one second refractive layer. A second refractive layer is located between two adjacent first refractive layers in the at least two first refractive layers. A refractive index of a first refractive layer in the at least two first refractive layers is less than a refractive index of the second refractive layer.

In some embodiments, the display module further includes a transparent protective layer. The transparent protective layer is located on a side of the support plate facing away from the flexible display panel, and an orthographic projection of the transparent protective layer on the support plate covers the light-transmissive hole.

In some embodiments, a minimum distance between a border of the orthographic projection of the transparent protective layer on the support plate and the light-transmissive hole is greater than or equal to 0.5 mm.

In some embodiments, a modulus of the transparent protective layer is in a range of 8 MPa to 100 MPa, inclusive.

In some embodiments, a thickness of the transparent protective layer gradually decreases from a center to an edge of the transparent protective layer.

In some embodiments, a maximum thickness of the transparent protective layer is d0, and d0 is greater than or equal to 20 μm and less than or equal to 50 μm (20 μm≤ d0≤50 μm).

In some embodiments, the support plate includes a first metal layer. A thickness of the first metal layer is d1, and d1 is greater than or equal to 80 μm and less than or equal to 300 μm (80 μm≤ d1≤300 μm).

In some embodiments, the support plate includes a second metal layer and an auxiliary support layer. The auxiliary support layer is located on a side of the second metal layer proximate to the flexible display panel, and a unit weight of the auxiliary support layer is less than a unit weight of the second metal layer. A sum of a thickness of the second metal layer and a thickness of the auxiliary support layer is d2, and d2 is greater than or equal to 80 μm and less than or equal to 300 μm (80 μm≤ d2≤300 μm).

In some embodiments, a material of the auxiliary support layer includes carbon fiber.

In some embodiments, the display module further includes a first adhesive layer, a second adhesive layer and a transparent elastomer layer that are stacked. The transparent elastomer layer is located between the first adhesive layer and the second adhesive layer, and the first adhesive layer is located on a side of the transparent elastomer layer proximate to the support plate. A light transmittance of the transparent elastomer layer is greater than or equal to 95%.

In some embodiments, an elastic modulus of the transparent elastomer layer is in a range of 40 MPa to 500 MPa, inclusive.

In some embodiments, a material of the transparent elastomer layer includes at least one of a thermoplastic polyurethane elastomer, a thermoplastic elastomer or a thermoplastic polyester elastomer.

In some embodiments, the display module further includes a light converging layer. The light converging layer includes a plurality of microlenses arranged at intervals, and the plurality of microlenses are located between the transparent elastomer layer and the first adhesive layer or between the transparent elastomer layer and the second adhesive layer. An orthographic projection of the plurality of microlenses on the display surface at least partially overlaps with the orthographic projection of the transparent support structure on the display surface.

In some embodiments, the plurality of microlenses are located between the transparent elastomer layer and the second adhesive layer. At least one of microlens in the plurality of microlenses includes a plurality of optical film layers that are stacked. In two adjacent optical film layers, a refractive index of an optical film layer close to the support plate is less than a refractive index of an optical film layer away from the support plate. A refractive index of an optical film layer, closest to the support plate, in the plurality of optical film layers is greater than a refractive index of the transparent elastomer layer.

In some embodiments, a material of the transparent support structure includes at least one of ultra-thin glass, polyethylene terephthalate, polymethyl methacrylate or polycarbonate.

In some embodiments, a dimension of the light-shielding portion in a direction directed from the transparent support structure to the support plate is d3, and d3 is greater than or equal to 0.1 mm and less than or equal to 1 mm (0.1 mm≤ d3≤1 mm).

In some embodiments, the support plate includes a first support portion, a second support portion and a bendable portion located between the first support portion and the second support portion, and the bendable portion has a plurality of grooves. There is at least one light-transmissive hole, and the at least one light-transmissive hole is located in the first support portion and/or the second support portion.

In another aspect, a display apparatus is provided. The display apparatus includes the display module according to any one of the embodiments above, and an optical device. The optical device is located on a side of the support plate facing away from the flexible display panel, and an orthographic projection of the optical device on the support plate at least partially overlaps with the light-transmissive hole.

### BRIEF DESCRIPTION OF THE DRAWINGS

In order to describe technical solutions in the present disclosure more clearly, accompanying drawings to be used in some embodiments of the present disclosure will be introduced briefly below. Obviously, the accompanying drawings to be described below are merely accompanying drawings of some embodiments of the present disclosure, and a person of ordinary skill in the art can obtain other drawings according to these drawings. In addition, the accompanying drawings to be described below may be regarded as schematic diagrams, but are not limitations on actual sizes of products, actual processes of methods, and actual timings of signals involved in the embodiments of the present disclosure.

FIG. 1 is a structural diagram of a display module provided in some embodiments of the present disclosure;

FIG. 2 is a sectional structural view taken along the line A-A′ in FIG. 1;

FIG. 3 is a structural diagram of a flexible display panel provided in some embodiments of the present disclosure;

FIG. 4 is another sectional structural view taken along the line A-A′ in FIG. 1;

FIG. 5 is yet another sectional structural view taken along the line A-A′ in FIG. 1;

FIG. 6 is yet another sectional structural view taken along the line A-A′ in FIG. 1;

FIG. 7 is yet another sectional structural view taken along the line A-A′ in FIG. 1;

FIG. 8 is yet another sectional structural view taken along the line A-A′ in FIG. 1;

FIG. 9 is yet another sectional structural view taken along the line A-A′ in FIG. 1;

FIG. 10 is yet another sectional structural view taken along the line A-A′ in FIG. 1;

FIG. 11 is a structural diagram of a microlens in FIG. 10;

FIG. 12A is a structural diagram of a support plate provided in some embodiments of the present disclosure;

FIG. 12B is a structural diagram of another support plate provided in some embodiments of the present disclosure;

FIG. 12C is a structural diagram of yet another support plate provided in some embodiments of the present disclosure;

FIG. 12D is a structural diagram of yet another support plate provided in some embodiments of the present disclosure;

FIG. 13 is yet another sectional structural view taken along the line A-A′ in FIG. 1;

FIG. 14 is yet another sectional structural view taken along the line A-A′ in FIG. 1;

FIG. 15 is a flow diagram of a method for manufacturing a display module provided in some embodiments of the present disclosure;

FIG. 16 is a sectional structural view of a display apparatus provided in some embodiments of the present disclosure; and

FIG. 17 is yet another sectional structural view taken along the line A-A′ in FIG. 1.

### DETAILED DESCRIPTION

Technical solutions in some embodiments of the present disclosure will be described clearly and completely with reference to the accompanying drawings below. Obviously, the described embodiments are merely some but not all embodiments of the present disclosure. All other embodiments obtained by a person of ordinary skill in the art based on the embodiments of the present disclosure shall be included in the protection scope of the present disclosure.

Unless the context requires otherwise, throughout the description and the claims, the term “comprise” and other forms thereof such as the third-person singular form “comprises” and the present participle form “comprising” are construed as an open and inclusive meaning, i.e., “including, but not limited to”. In the description of the specification, the terms such as “one embodiment”, “some embodiments”, “exemplary embodiments”, “example”, “specific example” or “some examples” are intended to indicate that specific features, structures, materials or characteristics related to the embodiment(s) or example(s) are included in at least one embodiment or example of the present disclosure. Schematic representation of the above terms do not necessarily refer to the same embodiment(s) or example(s). In addition, the specific features, structures, materials or characteristics may be included in any one or more embodiments or examples in any suitable manner.

Hereinafter, the terms such as “first” and “second” are used for descriptive purposes only, and are not to be construed as indicating or implying the relative importance or implicitly indicating the quantity of indicated technical features. Thus, a feature defined with “first” or “second” may explicitly or implicitly include one or more of the features. In the description of the embodiments of the present disclosure, the terms “a plurality of”, “the plurality of” and “multiple” each mean two or more unless otherwise specified.

The phrase “at least one of A, B and C” has a same meaning as the phrase “at least one of A, B or C”, and they both include the following combinations of A, B and C: only A, only B, only C, a combination of A and B, a combination of A and C, a combination of B and C, and a combination of A, B and C.

The phrase “A and/or B” includes the following three combinations: only A, only B, and a combination of A and B.

In addition, the phase “based on” used is meant to be open and inclusive, since a process, step, calculation or other action that is “based on” one or more of the stated conditions or values may, in practice, be based on additional conditions or values exceeding those stated.

As used herein, the term such as “substantially” or “approximately” includes a stated value and an average value within an acceptable range of deviation of a particular value. The acceptable range of deviation is determined by a person of ordinary skill in the art in view of measurement in question and the error associated with the measurement of a particular quantity (i.e., the limitation of the measurement system).

It will be understood that, in a case where a layer or component is referred to as being on another layer or substrate, it may be that the layer or component is directly on the another layer or substrate; or it may be that intermediate layer(s) exist between the layer or component and the another layer or substrate.

Exemplary embodiments are described herein with reference to sectional views and/or plan views as idealized exemplary drawings. In the accompanying drawings, thicknesses of layers and sizes of regions are enlarged for clarity. Variations in shapes relative to the accompanying drawings due to, for example, manufacturing technologies and/or tolerances may be envisaged. Therefore, the exemplary embodiments should not be construed as being limited to the shapes of the regions shown herein, but including deviations due to, for example, manufacturing. For example, an etched region shown to have a rectangular shape generally has a feature of being curved. Therefore, the regions shown in the accompanying drawings are schematic in nature, and their shapes are not intended to show actual shapes of regions in an apparatus, and are not intended to limit the scope of the exemplary embodiments.

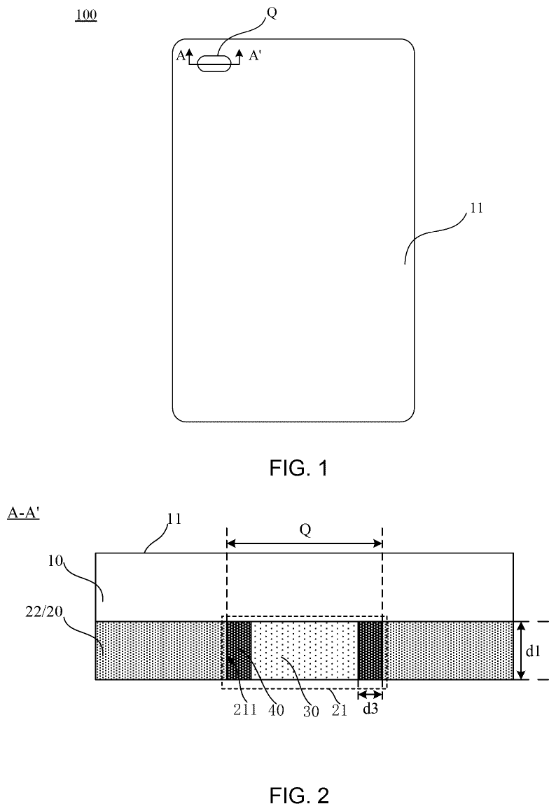

FIG. 1 is a structural diagram of a display module provided in some embodiments of the present disclosure; and FIG. 2 is a sectional structural view taken along the line A-A′ in FIG. 1. Referring to FIGS. 1 and 2, some embodiments of the present disclosure provide the display module 100. The display module 100 includes a flexible display panel 10, a support plate 20, a transparent support structure 30, and a light-shielding portion 40.

As shown in FIG. 1, the flexible display panel 10 includes a display surface 11, and the display surface 11 has light-transmissive region Q. Here, the light-transmissive region Q is at least partial region of the display surface 11 of the flexible display panel 10. FIG. 1 is illustrated by considering an example in which the light-transmissive region Q is located at a position of the display surface 11 far away from a lower frame of the display module 100. It will be understood that, in some other embodiments, the light-transmissive region Q may also be located at a position of the display surface 11 proximate to the lower frame of the display module 100.

For example, the flexible display panel 10 includes an organic light-emitting diode (OLED) display panel, a quantum dot light-emitting diode (QLED) display panel, or a micro light-emitting diode (Micro-LED) display panel.

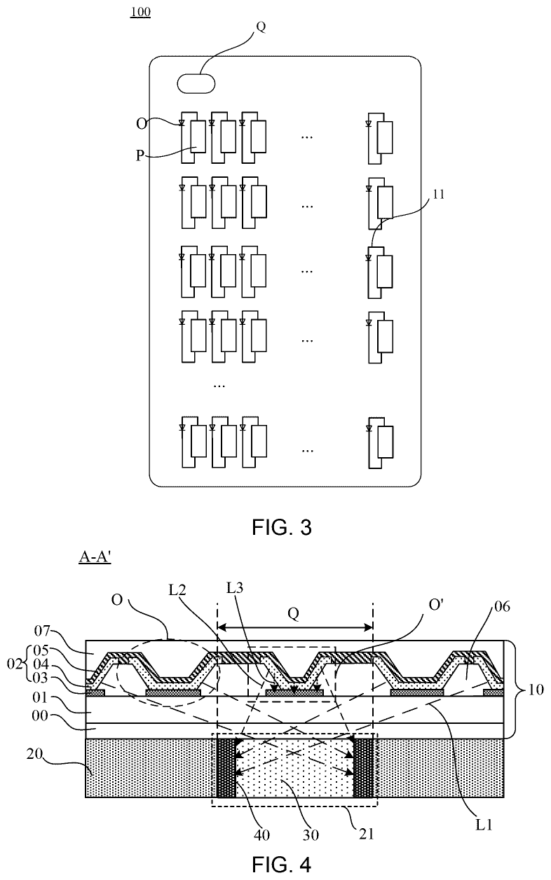

FIG. 3 is a structural diagram of the flexible display panel provided in some embodiments of the present disclosure. Referring to FIG. 3, the flexible display panel 10 includes pixel driving circuits P and a plurality of light-emitting devices O. The pixel driving circuit P drives the light-emitting device O to emit light, so that the flexible display panel 10 may display an image. It will be understood that, the light-transmissive region Q is used for camera shooting in a camera shooting phase and displaying the image together with other region of the display surface 11 in a display phase.

FIG. 3 is illustrated by considering an example of pixel driving circuits P and light-emitting devices O at a position of the display surface 11 other than the light-transmissive region Q. A connection between a pixel driving circuit P and a light-emitting device Q in the light-transmissive region Q is the same as a connection between the pixel driving circuit P and the light-emitting device O at the position of the display surface 11 other than the light-transmissive region Q, and a manner for driving the light-emitting device Q in the light-transmissive region Q is the same as a manner for driving the light-emitting device O at the position of the display surface 11 other than the light-transmissive region Q. Pixels per inch (PPI) in the light-transmissive region Q are less than pixels per inch at the position of the display surface 11 other than the light-transmissive region Q, so that an under-screen camera's requirement for light transmittance is met.

The light-transmissive region Q may be a camera shooting region or a fingerprint recognition region. Following description is made by considering an example in which the light-transmissive region Q is the camera shooting region, and the same applies to the fingerprint recognition.

As shown in FIG. 2, the support plate 20 is located on a side of the flexible display panel 10 facing away from the display surface 11, and the support plate 20 has a light-transmissive hole 21. The support plate 20 may play a role of supporting the flexible display panel 10. Image light may pass through the light-transmissive hole 21 and reach the under-screen camera, so that a full-screen design for the display module 10 is achieved.

FIG. 2 is illustrated by considering an example in which a border of an orthographic projection of a light-transmissive region Q on a plane where the support plate 20 is located coincides with a border of the light-transmissive hole 21. It will be understood that, in some other embodiments, the orthographic projection of the light-transmissive region Q on the plane where the support plate 20 is located may cover the light-transmissive hole 21 or overlap with a part of the light-transmissive hole 21.

In some of the implementation manners mentioned above, in order to meet the requirement of the under-screen camera, the light-transmissive hole 21 is arranged in the support plate 20 that cannot transmit light. However, since strength of each film layer of the flexible display panel 10 is not enough, which results in a depression formed at a position, corresponding to the light-transmissive hole 21, of the display surface 11 of the flexible display panel 10 when the support plate 20 and the flexible display panel 10 are bonded. As a result, poor appearance such as impression and indentation may be clearly observed at the position, corresponding to the light-transmissive hole 21, of the display surface 11 of the flexible display panel 10.

As for the display module 100 provided in the embodiments of the present disclosure, with continued reference to FIG. 2, the transparent support structure 30 is filled in the light-transmissive hole 21, and an orthographic projection of the transparent support structure 30 on the display surface 11 at least partially overlaps with the light-transmissive region Q. The transparent support structure 30 may support the flexible display panel 10 together with the support plate 20, so as to reduce or eliminate the impression problem of the display module 100 caused by the absence of force at the position of the light-transmissive hole 21.

FIG. 2 is illustrated by considering an example in which a surface of the transparent support structure 30 proximate to the flexible display panel 10 is flush with a surface of the support plate 20 proximate to the flexible display panel 10, and a surface of the transparent support structure 30 facing away from the flexible display panel 10 is flush with a surface of the support plate 20 facing away from the flexible display panel 10. As a result, it further enables the transparent support structure 30 to completely fill the light-transmissive hole 21, so that the impression problem of the display module 100 caused by the absence of force at the position of the light-transmissive hole 21 may be reduced or eliminated.

It will be understood that, in some other embodiments, the surface of the transparent support structure 30 proximate to the flexible display panel 10 is flush with the surface of the support plate 20 proximate to the flexible display panel 10, and the surface of the transparent support structure 30 facing away from the flexible display panel 10 is located in the light-transmissive hole 21. Alternatively, the surface of the transparent support structure 30 proximate to the flexible display panel 10 is located in the light-transmissive hole 21, and the surface of the transparent support structure 30 facing away from the flexible display panel 10 is flush with the surface of the support plate 20 facing away from the flexible display panel 10. Still alternatively, the surface of the transparent support structure 30 proximate to the flexible display panel 10 and the surface of the transparent support structure 30 facing away from the flexible display panel 10 are both located in the light-transmissive hole 21.

Since certain uncontrollable errors exist, a surface of the transparent support structure 30 being flush with a surface of the support plate 20 includes that the surface of the transparent support structure 30 is absolutely flush with the surface of the support plate 20 and the surface of the transparent support structure 30 is approximately flush with the surface of the support plate 20. That is, a fluctuating range of a level difference between the surface of the transparent support structure 30 and the surface of the support plate 20 does not exceed an error threshold, which may also be considered that the two surfaces are relatively flush with each other. The error threshold may be, for example, 0.5 mm.

FIG. 4 is another sectional structural diagram taken along the line A-A′ in FIG. 1. As shown in FIG. 4, the flexible display panel 10 includes a base substrate 00, a driving circuit layer 01, a light-emitting device layer 02, a pixel define layer 06 and an encapsulation layer 07. Light-emitting devices in the light-emitting device layer 02 are driven by using the driving circuit layer 01 to emit light, so that the image is displayed. The light-emitting device layer 02 includes light-emitting devices O′ located in the light-transmissive region Q and light-emitting devices O located in a region of the display surface other than the light-transmissive region Q. The light-emitting device O and the light-emitting device O′ each include an anode layer 03, a cathode layer 05, and a light-emitting layer 04 located between the anode layer 03 and the cathode layer 05.

For example, a size of the light-emitting device O′ is smaller than a size of the light-emitting device O. Thus, the light transmittance of the light-transmissive region Q may be improved.

For example, a density of the light-emitting devices O′ needs to be less than a density of the light-emitting devices O. Thus, the light transmittance of the light-transmissive region Q may be improved.

FIG. 4 is illustrated by considering an example in which the light-emitting devices O have the same size. It will be noted that, in some other embodiments, in a case where the light-emitting devices O include red light-emitting devices, green light-emitting devices, and blue light-emitting devices, a light-emitting layer 04 of the blue light-emitting device has the lowest luminous efficiency, a light-emitting layer 04 of the red light-emitting device has the second lowest luminous efficiency, and a light-emitting layer 04 of the green light-emitting device has the highest luminous efficiency. Therefore, the blue light-emitting device may have the largest size, the red light-emitting device may have the second largest size, and the green light-emitting device may have the smallest size, which helps to improve the colour cast of the display module 100. The light-emitting devices O′ in the light-transmissive region Q are also suitable for the theory above, which will not be repeated here.

As shown in FIG. 4, the light-shielding portion 40 is located on at least part of a sidewall 211 of the light-transmissive hole 21. Light L1 emitted from the light-emitting device O reaches the light-shielding portion 40 inside the light-transmissive hole 21, and light L2 emitted from the light-emitting device O′ may also reach the light-shielding portion 40 inside the light-transmissive hole 21. The light-shielding portion 40 may absorb the light L1 and the light L2, and thus the light leakage at the position of the light-transmissive hole 21 in the support plate 20 may be improved. In addition, since the anode layer 03 of the light-emitting device O′ is located between the light-emitting layer 04 and the light-transmissive hole 21, and the anode layer 03 is generally made of a metal material, Light L3 emitted from the light-emitting device O′ vertically downward will be reflected by a corresponding anode layer 03 and exit out of the display module 100. Therefore, the anode layer 03 may be used to prevent the influence of the light L3 emitted from the light-emitting device O′ on an imaging effect.

The light-shielding portion 40 is located on the at least part of the sidewall 211 of the light-transmissive hole 21. The light-shielding portion 40 may be of a closed loop structure, and be disposed around all of the transparent support structure 30. Alternatively, the light-shielding portion 40 may be of a non-closed loop structure, and be disposed around part of the transparent support structure 30. The light-shielding portion 40 having each of the structures above may improve the light leakage at the position of the light-transmissive hole 21.

For example, the light-shielding portion 40 may be a light-shielding adhesive. The light-shielding adhesive may improve the light leakage at the position of the light-transmissive hole 21. In addition, the light-shielding adhesive may also be used for fixing the transparent support structure 30 to the support plate 20, so as to prevent the transparent support structure 30 from falling off relative to the support plate 20. As a result, it helps improve the yield of the display module 100.

For example, the light-shielding adhesive may be made of at least one adhesive material such as epoxy resin series material, silica gel series material, and methyl methacrylate series material. The light-shielding adhesive may shield light and fix the transparent support structure 30.

In summary, for the display module 100 provided in the embodiments of the present disclosure, the light-transmissive hole 21 is filled with the transparent support structure 30. The transparent support structure 30 does not have a great influence on the light transmittance of the light-transmissive hole 21, so as to meet normal requirements of the under-screen camera; and the transparent support structure 30 may also bonded to the support plate 20 and support the flexible display panel 10, which may reduce or eliminate the impression problem caused by the absence of force at the position of the light-transmissive hole 21. Moreover, the light-shielding portion 40 is disposed on the at least part of the sidewall 211 of the light-transmissive hole 21, and the light-shielding portion 40 may shield light emitted from light-emitting devices inside the flexible display panel 10 from entering the light-transmissive hole 21, thereby improving the light leakage at the position of the light-transmissive hole 21 in the support plate 20.

In some embodiments, with continued reference to FIG. 2, a material of transparent support structure 30 includes at least one of ultra-thin glass, polyethylene terephthalate, polymethyl methacrylate, or polycarbonate.

For example, the material of the transparent support structure 30 may be any one of ultra-thin glass, polyethylene terephthalate, polymethyl methacrylate, or polycarbonate, or a combination of any two or more thereof. The transparent support structure 30 is filled in the light-transmissive hole 21, and the transparent support structure 30 may function to support the flexible display panel 100 to avoid the impression, and also effectively improve the light transmittance of the light-transmissive hole 21.

In some embodiments, with continued reference to FIG. 2, the light-shielding portion 40 has a dimension d3 in a direction directed from the transparent support structure 30 to the support plate 20, and the dimension d3 is greater than or equal to 0.1 mm and less than or equal to 1 mm (i.e., 0.1 mm≤ d3≤1 mm).

In a case where the dimension of the light-shielding portion 40 is equal to or approaches 0.1 mm, the light-shielding portion 40 is relatively narrow. In this case, the light-shielding portion 40 may be used to fix the transparent support structure 30; the light-shielding portion 40 is used to absorb interference light emitted from an inside of the flexible display panel 10, and shielding of the light-shielding portion 40 on image light that needs to pass through the light-transmissive hole 21 may also be reduced, which improves the transmittance of the image light, thereby improving the imaging quality. In a case where the dimension of the light-shielding portion 40 is equal to or approaches 1 mm, the light-shielding portion 40 is relatively wide. In this case, it can not only allow enough image light to pass through the light-transmissive hole, but also absorb the interference light more effectively, and further make the transparent support structure 30 be bonded and fixed, which prevents the transparent support structure 30 from falling off relative to the support plate 20. As a result, the yield of the display module 100 is improved.

For example, the dimension of the light-shielding portion 40 in a lateral direction may be 0.1 mm, 0.3 mm, 0.5 mm, or 1 mm.

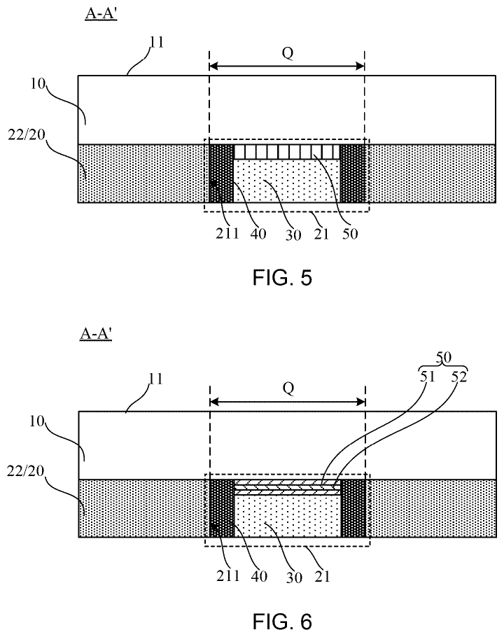

FIG. 5 is yet another sectional structural view taken along the line A-A′ in FIG. 1. In some embodiments, referring to FIGS. 1 and 5, the display module 100 further includes a reflection-reducing layer 50. The reflection-reducing layer 50 is located in the light-transmissive hole 21; the reflection-reducing layer 50 and the transparent support structure 30 are stacked.

In the embodiments, the reflection-reducing layer 50 is arranged opposite to the transparent support structure 30 in the light-transmissive hole 21. Thus, the light transmittance of the light-transmissive hole 21 may be increased by the reflection-reducing layer 50, so that the amount of external light entering the light-transmissive region Q is greatly increased. As a result, the shooting effect and the face identification precision of a front camera are improved.

For example, FIG. 5 is illustrated by considering an example in which the reflection-reducing layer 50 is located on a side of the transparent support structure 30 proximate to the flexible display panel 10. It will be understood that, in some other embodiments, the reflection-reducing layer 50 may be sandwiched between two layers of the transparent support structure 30; or the reflection-reducing layer 50 may be located on a side of the transparent support structure 30 facing away from the flexible display panel 10.

FIG. 6 is yet another sectional structural view taken along the line A-A′ in FIG. 1. In some embodiments, referring to FIGS. 1 and 6, the reflection-reducing layer 50 includes at least two first refractive layers 51 and at least one second refractive layer 52. A second refractive layer 52 is located between two adjacent first refractive layers 51. A refractive index of the first refractive layers 51 is less than a refractive index of the second refractive layer 52.

For example, the reflection-reducing layer 50 includes the first refractive layers 51 and the second refractive layer(s) 52 that are alternately stacked. A film layer closest to the flexible display panel 10 and a film layer closest to the support plate 20 in film layers of the reflection-reducing layer 50 are both first refractive layers 51. That is, an upper outermost film layer of the reflection-reducing layer 50 and a lower outermost film layer of the reflection-reducing layer 50 are both the first refractive layers 51. Based on the structure, the refractive index of the first refractive layer 51 is set to be less than the refractive index of the second refractive layer 52, and the refractive index of a first refractive layer 51 close to the transparent support structure 30 is set to be less than a refractive index of the transparent support structure 30. When the external light is incident on the reflection-reducing layer 50, parts of the light are reflected back from two surfaces of the reflection-reducing layer 50, respectively, and the reflected light (two lines of waves) interferes with each other. By setting a thickness of any one of the first refractive layer 51 or the second refractive layer 52 of the reflection-reducing layer 50 is at the nanometer scale (¼ of a wavelength of visible light), the two lines of reflected light waves will be mutually cancelled, so that the reflection-reducing effect is achieved. As a result, the amount of external light entering the light-transmissive region Q is greatly improved, and thus the shooting effect and the face identification precision of the front camera are improved.

FIG. 6 is illustrated by considering an example in which the reflection-reducing layer 50 includes two first refractive layers 51 and one second refractive layer 52. It can be understood that, in some other embodiments, the reflection-reducing layer 50 may be of a three-layer structure, a five-layer structure, a seven-layer structure, or a structure of more layers.

For example, the first refractive layer 51 may be made of silicon oxide, and the second refractive layer 52 may be made of niobium oxide.

For example, the reflection-reducing layer 50 may be formed on the transparent support structure 30 by vapor deposition. For example, in the case where the reflection-reducing layer 50 includes two first refractive layers 51 and one second refractive layer 52, the first refractive layers 51 and the second refractive layers 52 may be sequentially formed on the transparent support structure 30 by vapor deposition.

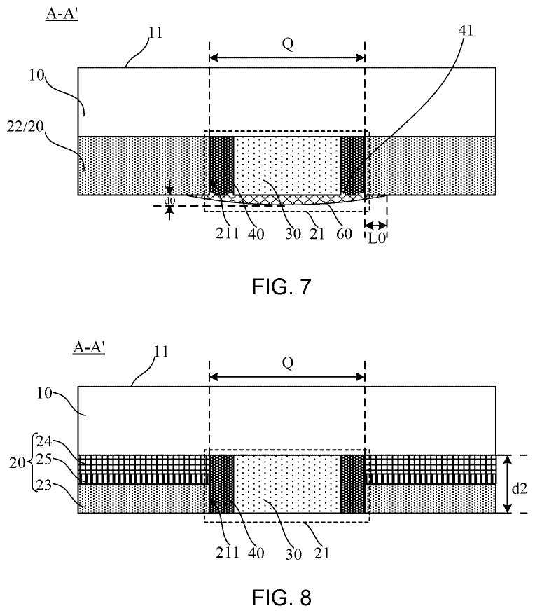

FIG. 7 is yet another sectional structural view taken along the line A-A′ in FIG. 1. In some embodiments, referring to FIGS. 1 and 7, the display module 100 further includes a transparent protective layer 60. The transparent protective layer 60 is located on a side of the support plate 20 facing away from the flexible display panel 10. An orthographic projection of the transparent protective layer 60 on the support plate 20 covers the light-transmissive hole 21.

In some embodiments, since the transparent protective layer 60 is formed on the side of the light-transmissive hole 21 facing away from the flexible display panel 10, and a surface of the transparent protective layer 60 facing away from the support plate 20 is a relatively flat surface, the transparent protective layer 60 may be used to fill recessed portions 41 that are formed due to step differences between film structures inside the light-transmissive hole 21, thereby improving an impression problem of the display module 100 caused by the recessed portions 41.

For example, since the light-shielding portion 40 disposed inside the light-transmissive hole 21 shrinks after being cured, the recessed portions 41 are formed in the light-shielding portion 40 at corresponding positions; the recessed portion 41 cannot subject to a force, so that the impression problem occurs during subsequent process of the flexible display panel 10 being bonded. Based on this, the transparent protective layer 60 may be disposed at the position of the light-transmissive hole 21 on the side of the support plate 20 facing away from the flexible display panel 10, a surface of the transparent protective layer 60 proximate to the support plate 20 may fill the recessed portion 41, and the surface of the transparent protective layer 60 facing away from the support plate 20 is a relatively flat surface, so that the impression caused by the light-shielding portion 40 may be reduced or eliminated.

For example, a material of the transparent protective layer 60 may include at least one of a silicone gel or an epoxy gel.

In some embodiments, with continued reference to FIG. 7, a minimum distance L0 between a border of the orthographic projection of the transparent protective layer 60 on the support plate 20 and the light-transmissive hole 21 is greater than or equal to 0.5 mm.

L0 is greater than or equal to 0.5 mm, which may guarantee that the transparent protective layer 60 covers all of the light-transmissive hole 21, thereby avoiding the impression problem caused by the step differences in the light-transmissive hole 21. In addition, it may also avoid that the light-transmissive hole 21 cannot be completely covered due to an error in fabricating the transparent protective layer 60, so as to avoid that the impression problem cannot be solved. The orthographic projection of the transparent protective layer 60 on the support plate 20 covers a portion of the support plate 20, and at least part of other exposed region of the support plate 20 may be used for realizing grounding, so that an static electricity inside the display module 100 is easy to be led out. As a result, the yield of the display module 100 is improved.

For example, the minimum distance L0 between the border of the orthographic projection of the transparent protective layer 60 on the support plate 20 and the light-transmissive hole 21 may be 0.5 mm, 0.8 mm, 1 mm, etc.

In some embodiments, and with continued reference to FIG. 7, a modulus of the transparent protective layer 60 is in a range of 8 MPa to 100 MPa, inclusive.

In a case where the modulus of the transparent protective layer 60 after cured is equal to or approaches 8 MPa, the modulus of the transparent protective layer 60 after cured is relatively small, so that a secondary impression problem of the display module 100 caused by a large modulus of the transparent protective layer 60 after cured may be avoided; and the impression problem of the display module 100 caused by the light-transmissive hole 21 may be improved. In a case where the modulus of the transparent protective layer 60 after cured is equal to or approaches 100 MPa, the modulus of the transparent protective layer 60 after cured is relatively large, which may be more beneficial for the transparent protective layer 60 to improve the impression problem of the display module 100.

For example, the modulus of the transparent protective layer 60 may be 8 MPa, 50 MPa, or 100 MPa.

In some embodiments, with continued reference to FIG. 7, the thickness of the transparent protective layer 60 gradually decreases from a center to an edge of the transparent protective layer 60.

For example, the surface of the transparent protective layer 60 proximate to the support plate 20 is attached to the support plate 20. Based on this, the thickness of the transparent protective layer 60 gradually decreases to zero from the center to the edge of the transparent protective layer 60. The surface of the transparent protective layer 60 facing away from the support plate 20 forms a relatively flat interface, so that the impression problem of the display module 100 may be reduced.

For example, the transparent protective layer 60 may be formed on the support plate 20 by spin coating, which may further ensure that the thickness of the transparent protective layer 60 gradually decreases from the center to the edge of the transparent protective layer 60. But it is not limited to this, and the transparent protective layer 60 may be fabricated in other realizable manners.

FIG. 7 is illustrated by considering an example in which the surface of the transparent protective layer 60 facing away from the support plate 20 is in an arc shape. It can be understood that, in some other embodiments, the surface of the transparent protective layer 60 facing away from the support plate 20 may be in other shape with gradually changed thickness, and the shape of the transparent protective layer 60 is not specifically limited.

In some embodiments, with continued reference to FIG. 7, a maximum thickness of the transparent protective layer 60 is do, do is greater than or equal to 20 μm and less than or equal to 50 μm (i.e., 20 μm≤ d0≤50 μm).

In a case where the maximum thickness do of the transparent protective layer 60 is equal to or approaches 20 μm, the maximum thickness do of the transparent protective layer 60 is relatively small, which is convenient for the lightness and thinness of the display module 100; and the transparent protective layer 60 may also fill the recessed portions 41 in the light-transmissive hole 21, so as to improve the impression problem of the display module 100. In a case where the maximum thickness do of the transparent protective layer 60 is equal to or approaches 50 μm, the maximum thickness do of the transparent protective layer 60 is relatively large, which may beneficial for the transparent protective layer 60 to fill the recessed portions 41 in the light-transmissive hole 21, thereby improving the impression problem of the display module 100.

For example, the maximum thickness do of the transparent protective layer 60 may be 20 μm, 30 μm, 40 μm, or 50 μm.

In some embodiments, with continued reference to FIG. 2, the support plate 20 includes a first metal layer 22. A thickness of the first metal layer 22 is d1, and d1 is greater than or equal to 80 μm and less than or equal to 300 μm (i.e., 80 μm≤ d1≤300 μm).

In a case where the thickness of the first metal layer 22 is equal to or approaches 80 μm, it may reduce a weight of the support plate 20 and meet the support force requirement of the support plate 20. In a case where the thickness of the first metal layer 22 is equal to or approaches 300 μm, it may meet the support force requirement of the support plate 20 and avoid the weight of the support plate 20 from being excessively large, so as to avoid the user experience of the display module 100 being affected, thereby ensuring the user experience.

For example, the first metal layer 22 may be made of a metal material such as stainless steel (SUS), copper, or a titanium alloy, and a thickness of the first metal layer 22 may be 80 μm, 100 μm, 200 μm, or 300 μm.

FIG. 8 is yet another sectional structural view taken along the line A-A′ in FIG. 1. In some embodiments, referring to FIGS. 1 and 8, the support plate 20 includes a second metal layer 23 and an auxiliary support layer 24. The auxiliary support layer 24 is located on a side of the second metal layer 23 proximate to the flexible display panel 10. A unit weight of the auxiliary support layer 24 is less than a unit weight of the second metal layer 23. A sum of a thickness of the second metal layer 23 and a thickness of the auxiliary support layer 24 is d2, and d2 is greater than or equal to 80 μm and less than or equal to 300 μm (i.e., 80 μm≤ d2≤300 μm).

In the embodiments, the support plate 20 includes the second metal layer 23 and the auxiliary support layer 24, and the sum of the thickness of the second metal layer 23 and the thickness of the auxiliary support layer 24 is in a ranges of 80 μm to 300 μm, inclusive. Therefore, in a case where the sum of the thickness of the second metal layer 23 and the thickness of the auxiliary support layer 24 is equal to or approaches 80 μm, it may reduce the weight of the support plate 20 and meet the support force requirement of the support plate 20. In a case where the sum of the thickness of the second metal layer 23 and the thickness of the auxiliary support layer 24 is equal to or approaches 300 μm, it may meet the support force requirement of the support plate 20 and avoid the weight of the support plate 20 from being excessively large, so as to ensure the user experience. Based on this, the unit weight of the auxiliary support layer 24 is less than the unit weight of the second metal layer 23. Therefore, on a basis of an original thickness of the support plate 20 not changed, by adjusting a material of the support plate 20 and replacing a part of a second metal layer 23 with the auxiliary support layer 24, the weight of the second metal layer 23 is effectively reduced, and thus the weight of the support plate 20 is further reduced.

In addition, the auxiliary support layer 24 is disposed on the side of the second metal layer 23 proximate to the flexible display panel 10, so that grounding is easy to be achieved by the second metal layer, and the static electricity inside the display module 100 is easy to be led out. As a result, the yield of the display module 100 is improved.

For example, a material of the second metal layer 23 may be the same as the material of the first metal layer 22, and is the metal material such as stainless steel (SUS), copper, or the titanium alloy.

For example, the thickness of the second metal layer 23 may be 30 μm, 50 μm, or 100 μm. In a case where the thickness of the second metal layer 23 is equal to or approaches 30 μm, the thickness of the second metal layer 23 is relatively small, it may meet the support force requirement of the support plate 20 and significantly reduce the weight of the support plate 20.

In some embodiments, with continued reference to FIG. 8, the support plate 20 may further include an adhesive layer 25. The adhesive layer 25 is located between the second metal layer 23 and the auxiliary support layer 24. The adhesive layer 25 may be used to make the second metal layer 23 and the auxiliary support layer 24 be fixedly connected. For example, the adhesive layer 25 may be an optical clear adhesive (OCA).

In some embodiments, with continued reference to FIG. 8, a material of the auxiliary support layer 24 includes carbon fiber, and the carbon fiber has properties of high strength and good heat conductivity. Based on this, the support plate 20 includes the second metal layer 23 and the carbon fiber. It may improve the heat dissipation performance of the support plate 20 while meeting the support strength requirement of the support plate 20 and reducing the weight of the support plate 20. In addition, the auxiliary support layer 24 may be made of other material, such as rubber.

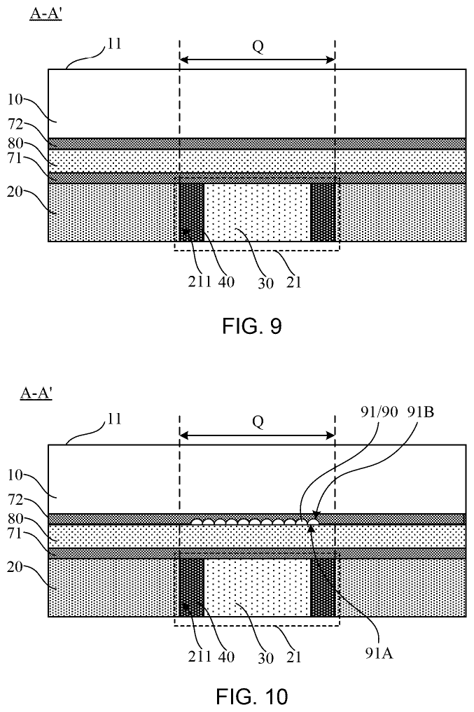

FIG. 9 is yet another sectional structural view taken along the line A-A′ in FIG. 1. In some embodiments, referring to FIGS. 1 and 9, the display module 100 further includes: a first adhesive layer 71, a second adhesive layer 72 and a transparent elastomer layer 80 that are stacked. The transparent elastomer layer 80 is located between the first adhesive layer 71 and the second adhesive layer 72, and the first adhesive layer 71 is located on a side of the transparent elastomer layer 80 proximate to the support plate 20. A light transmittance of the transparent elastomer layer 80 is greater than or equal to 95%.

In the embodiments, the display module 100 further includes the transparent elastomer layer 80, and the transparent elastomer layer 80 is located between the support plate 20 and the flexible display panel 10. Since the transparent elastomer layer 80 has a certain elasticity and a certain recovery performance, it may cushion a pressure during the support plate 20 and the flexible display panel 10 being attached and perform recovery after the attachment, thereby reducing the impression problem of the display module 100. In addition, since the light transmittance of the transparent elastomer layer 80 is greater than or equal to 95%, a material of the transparent elastomer layer belongs to a high-transmittance material, which may help improve the light transmittance and thus greatly improve the amount of the external light entering the light-transmissive region Q. As a result, the shooting effect and the face identification precision of the front camera are improved. The transparent elastomer layer 80 is adhered to the first adhesive layer 71 and the second adhesive layer 72 in a vertical direction; the first adhesive layer 71 is adhered to the support plate 20, and the second adhesive layer 72 is adhered to the flexible display panel 10.

For example, the first adhesive layer 71 and the second adhesive layer 72 may be both OCA, but it is not limited thereto, other adhesive may be used to achieve the fixing.

In some embodiments, with continued reference to FIG. 9, an elastic modulus of the transparent elastomer layer 80 is in a range of 40 MPa to 500 MPa, inclusive.

In a case where the elastic modulus of the transparent elastomer layer 80 is equal to or approaches 40 MPa, it may effectively improve the impression problem of the display module 100 while meeting the function of cushioning and shock absorption. In a case where the elastic modulus of the transparent elastomer layer 80 is equal to or approaches 500 MPa, it may play a good role of cushioning and shock absorption while reducing or even eliminating the impression problem of the display module 100.

For example, the elastic modulus of the transparent elastomer layer 80 may be 40 MPa, 100 MPa, 200 MPa, or 400 MPa.

Optionally, the thickness of the transparent elastomer layer 80 is in a range of 50 μm to 200 μm, inclusive, which avoids that the transparent elastomer layer 80 is too thin or too thick to play a role of cushioning and recovering. For example, the thickness of the transparent elastomer layer 80 may be 50 μm, 100 μm, or 200 μm.

In some embodiments, with continued reference to FIG. 9, a material of the transparent elastomer layer 80 includes any one of a thermoplastic polyurethane (TPU) elastomer, a thermoplastic elastomer (TPE), or a thermoplastic polyester elastomer (TPEE), or a combination of two or more thereof. In addition, the material of the transparent elastomer layer 80 is selected from the materials rather than a conventional foam material, so that the elastic modulus of the transparent elastomer layer 80 is relatively large. As a result, the transparent elastomer layer 80 may have better cushioning and recovery performance, and thus the impression problem of the display module 100 is reduced.

For example, in a case where the material of the transparent elastomer layer 80 is the thermoplastic polyurethane (TPU) elastomer, a material type of the TPU elastomer may be IWATANI ISR-TPS 50.

FIG. 10 is yet another sectional structural view taken along the line A-A′ in FIG. 1. In some embodiments, referring to FIGS. 1 and 10, the display module 100 further includes a light converging layer 90. The light converging layer 90 includes a plurality of microlenses 91 arranged at intervals. The plurality of microlenses 91 are located between the transparent elastomer layer 80 and the first adhesive layer 71 or between the transparent elastomer layer 80 and the second adhesive layer 72; an orthographic projection of the plurality of microlenses 91 on the display surface 11 at least partially overlaps with the orthographic projection of the transparent support structure 30 on the display surface 11.

In the embodiments, the display module 100 further includes the light converging layer 90, and the light converging layer 90 may converge light. By arranging the orthographic projection of the light converging layer 90 on the display surface 11 to at least partially overlap with the orthographic projection of transparent support structure 30 on the display surface 11, it may be possible to improve the light converging effect at the position of the transparent support structure 30, so as to meet the image light transmittance requirement of the light-transmissive region Q of the display module 100, thereby improving the camera shooting quality. FIG. 10 is illustrated by considering an example in which the plurality of microlenses 91 are located between the transparent elastomer layer 80 and the second adhesive layer 72. It will be understood that, in some other embodiments, as shown in FIG. 17, the plurality of microlenses 91 are located between the transparent elastomer layer 80 and the first adhesive layer 71.

In the embodiments, the light converging layer 90 is formed on a side of the transparent elastomer layer 80 proximate to the first adhesive layer 71 or on a side of the transparent elastomer layer 80 proximate to the second adhesive layer 72, and the light converging layer 90 may converge light. By arranging the orthographic projection of the light converging layer 90 on the display surface 11 to at least partially overlap with the orthographic projection of transparent support structure 30 on the display surface 11, it may be possible to improve the light converging effect at the position of the transparent support structure 30, so as to meet the image light transmittance requirement of the light-transmissive region Q of the display module 100, thereby improving the camera shooting quality.

With continued reference to FIG. 10, the microlens 91 is a convex lens, a flat surface 91A of the convex lens is located in a region of the light converging layer 90 proximate to the transparent elastomer layer 80, and a convex surface 91B of the convex lens is located in the region of the light converging layer 90 proximate to the second adhesive layer 72, so that the light is converged by the microlens 91. As a result, the image light transmittance requirement of the light-transmissive region Q of the display module 100 is met, and thus the camera shooting quality is improved.

For example, the light converging layer 90 may be made of a high refractive material, such as a material with a refractive index of about 1.7, so that the microlens 91 has a better light converging effect. The light converging layer 90 may be formed on the side of the transparent elastomer layer 80 proximate to the first adhesive layer 71 or on the side of the transparent elastomer layer 80 proximate to the second adhesive layer 72 in an ink jet printing (IKP) manner.

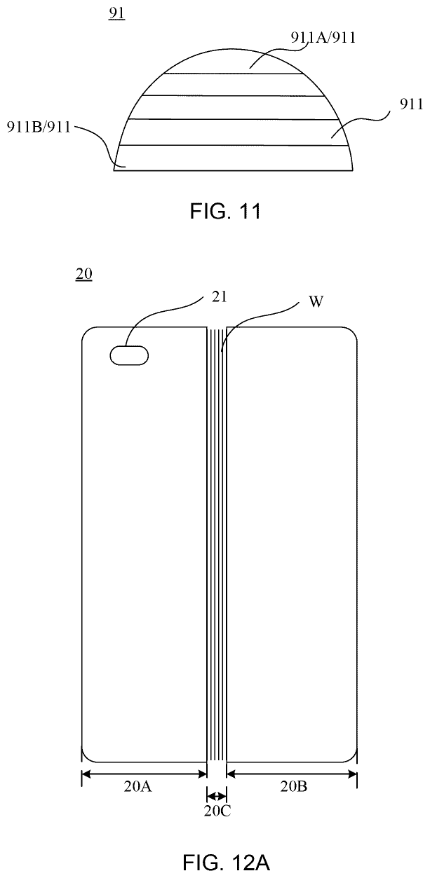

FIG. 11 is a structural diagram of the microlens shown in FIG. 10. In some embodiments, referring to FIGS. 10 and 11, the plurality of microlenses 91 are located between the transparent elastomer layer 80 and the second adhesive layer 72. At least one microlens 91 includes a plurality of optical film layers 911 that are stacked. In two adjacent optical film layers 911, a refractive index of an optical film layer 911 close to the support plate 20 is less than a refractive index of an optical film layer 911 away from the support plate 20. In addition, a refractive index of an optical film layer 911, closest to the support plate 20, in the plurality of optical film layers 911 is greater than a refractive index of the transparent elastomer layer 80.

In the embodiments, the light converging layer 90 is disposed on a side of the transparent elastomer layer 80 facing away from the support plate 20, and the at least one microlens 91 includes the plurality of optical film layers 911 that are stacked. The closer to the support plate 20, the smaller a refractive index of an optical film layer 911, and a refractive index of an optical mode layer 911 with the smallest refractive index is still larger than the refractive index of the transparent elastomer layer 80 (that is, a refractive index of an optical film layer disposed adjacent to the transparent elastomer layer 80 is larger than the refractive index of the transparent elastomer layer 80). As a result, refractive indices of film layers in the light converging layer 90 are sequentially decreased in a direction directed from the light converging layer 90 to the transparent elastomer layer 80, so that the light converging effect is achieved.

FIG. 11 is illustrated by considering an example in which the microlens 91 includes five optical film layers 91. For example, in general, the refractive index of the transparent elastomer layer 80 is approximately 1.5, and the refractive index of the optical film layer 911 is approximately 1.7. With continued reference to FIGS. 10 and 11, an optical film layer 911, closest to the flexible display panel 10, in the plurality of optical film layers 911 of the microlens 91 is an optical film layer 911A, and a refractive index of the optical film layer 911A is the largest; an optical film layer 911, closest to the support plate 20, in the plurality of optical film layers 911 of the microlens 91 is an optical film layer 911B, and a refractive index of the optical film layer 911B is the smallest. In addition, the refractive layer of the optical film layer 911B is larger than the refractive index of the transparent elastomer layer 80. The refractive indices of the optical film layers 911 are gradually decreased from 1.7 to 1.5 in a direction directed from the optical film layer 911A to the optical film layer 911B.

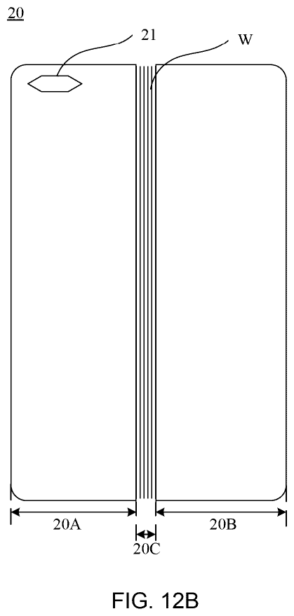

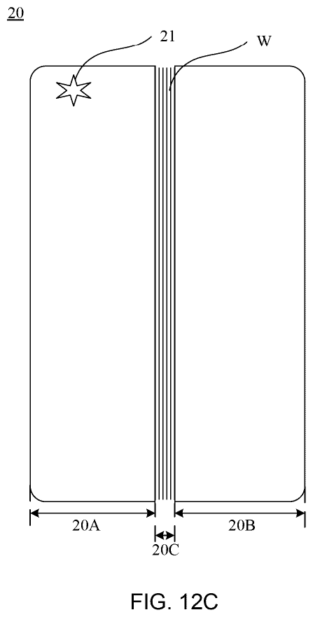

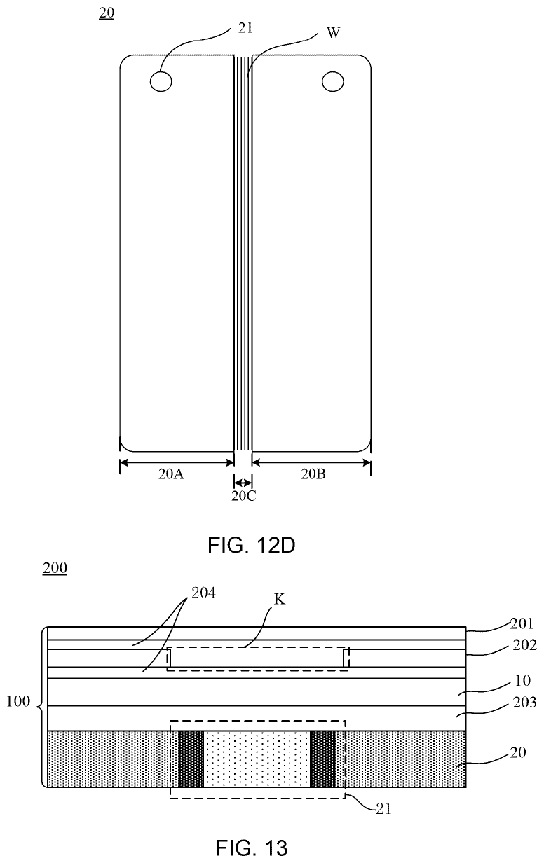

FIG. 12A is a structural view of the support plate provided in some embodiments of the present disclosure; FIG. 12B is a structural view of another support plate provided in some embodiments of the present disclosure; FIG. 12C is a structural view of yet another support plate provided in some embodiments of the present disclosure; and FIG. 12D is a structural view of yet another support plate provided in some embodiments of the present disclosure. In some embodiments, referring to FIGS. 12A to 12D, the support plate 20 includes a first support portion 20A, a second support portion 20B and a bendable portion 20C. The bendable portion 20C is located between the first support portion 20A and the second support portion 20B. The bendable portion 20C has a plurality of grooves W. There is at least one light-transmissive hole 21, and the at least one light-transmissive hole 21 is located in the first support portion 20A and/or the second support portion 20B.

The bendable portion 20C is used to enable the display module to be foldable. The bendable portion 20C has the plurality of grooves W, which facilitates the support plate 20 being bent. The number of light-transmissive holes 21 in the support plate 20 may be one or more, and may be set according to actual needs. In a case where only one light-transmissive hole 21 is included in the support plate 20, the light-transmissive hole 21 may be located in the first support portion 20A or the second support portion 20B. In a case where the support plate 20 includes a plurality of light-transmissive holes 21, the light-transmissive holes 21 may be located in the first support portion 20A or the second support portion 20B; or the plurality of light-transmissive holes 21 are dispersedly arranged in both the first support portion 20A and the second support portion 20B. An orthographic projection of the light-transmissive hole 21 on the plane where the support plate 20 is located may be in a shape of a circle, an ellipse, a square, a star or a polygon, and the shape of the light-transmissive hole 21 is not limited.

FIG. 12A is illustrated by considering an example in which the support plate 20 includes one light-transmissive hole 21, and the shape of the light-transmissive hole 21 is the ellipse; FIG. 12B is illustrated by considering an example in which the support plate 20 includes one light-transmissive hole 21, and the shape of the light-transmissive hole 21 is hexagon; FIG. 12C is illustrated by considering an example in which the support plate 20 includes one light-transmissive hole 21, and the shape of the light-transmissive hole 21 is a hexangular star; and FIG. 12D is illustrated by considering an example in which the support plate 20 includes two light-transmissive holes 21, the light-transmissive holes 21 each are circular, and the two light-transmissive holes 21 are located in the first support portion 20A and the second support portion 20B, respectively.

In addition, the support plate 20 is described by considering an example in which the support plate 20 is merely of a single-folding structure. That is, the support plate 20 is folded only once, and an exposed area of a corresponding display module 100 is reduced by one time. But it is not limited to this. The support plate 20 may be of a multi-folding structure, which is beneficial for the display module 100 to be subsequently folded into a structure having a smaller exposed area. The multi-folding structure includes two or more folding portions, and positions of the folding portions are not specifically limited.

FIG. 13 is yet another sectional structural view taken along the line A-A′ in FIG. 1. In some embodiments, referring to FIGS. 1 and 13, the display module 100 further includes: a cover plate 201, a polarizer 202, and a back film 203.

As shown in FIG. 13, the back film 203 is located between the flexible display panel 10 and the support plate 20, and the back film 203 may play a role of supporting the flexible display panel 10. The back film 203 may be adhered to the flexible display panel 10 and the support plate 20 by an adhesive layer. For example, in combination with FIG. 9, the back film 203 may be fixedly adhered to the support plate 20 by the second adhesive layer 72.

The cover plate 201 is located on the side of the flexible display panel 10 away from the support plate 20. The cover plate 201 may be used to protect the flexible display panel 10 and prevent the flexible display panel 10 from being scratched.

For example, the cover plate 201 is a flexible cover plate. A material of the cover plate 201 includes at least one of transparent polyimide and ultra-thin glass.

The polarizer 202 is located between the cover plate 201 and the flexible display panel 10. The polarizer 202 may be a circular polarizer. Here, the polarizer 202 may reduce reflection of the external light, so as to prevent a dazzling effect produced on display module 100.

For example, the polarizer 202 includes an opening K penetrating through the polarizer 202. The orthographic projection of the opening K on the plane where the support plate 20 is located at least partially overlaps with the light-transmissive hole 21, so that the influence of the polarizer 202 on the light transmittance at the position of the light-transmissive hole 21 is improved. In a case where the orthographic projection of the opening K on the plane where the support plate 20 is located completely covers the light-transmissive hole 21, it may avoid the influence of the polarizer 202 on the light transmittance at the position of the light-transmissive hole 21.

For example, a border of the orthographic projection of the opening K on the plane where the support plate 20 is located coincides with the border of the light-transmissive hole 21. In this case, the polarizer 202 is not likely to affect the light transmittance at the position of the light-transmissive hole 21. In addition, an area of the polarizer 202 except the opening K is not too small, which ensures a reflection-reducing effect of the polarizer 202 on the region of the display surface other than the light-transmissive hole 21. It will be noted that, since certain uncontrollable errors exist, the border of the orthographic projection of the opening K on the plane where the support plate 20 is located coinciding with the border of the light-transmissive hole 21 includes that the border of the orthographic projection of the opening K on the plane where the support plate 20 is located absolutely coincides with the border of the light-transmissive hole 21 and the border of the orthographic projection of the opening K on the plane where the support plate 20 is located approximately coincides with the border of the light-transmissive hole 21. That is, a fluctuating range of an error interval between the border of the orthographic projection of the opening K on the plane where the support plate 20 is located and the border of the light-transmissive hole 21 does not exceed an error threshold, which may also be considered that the two borders relatively coincide with each other. Here, the error threshold may be in a range of 0 μm to 0.5 μm, inclusive. Two surfaces of the polarizer 202 may be adhered to the cover plate 201 and the flexible display panel 10, respectively, and the surfaces of the polarizer 202 may be adhered to the cover plate 201 and the flexible display panel 10 through adhesive layers 204. A material of the adhesive layer includes a thermosetting resin adhesive or a photocurable resin. For example, the material of the adhesive layer is an OCA.

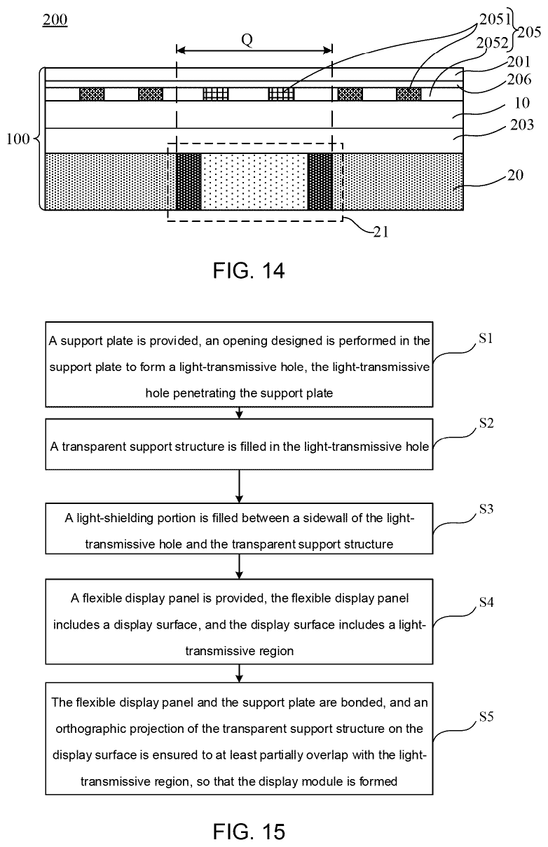

FIG. 14 is yet another sectional structural view taken along the line A-A′ in FIG. 1. In some embodiments, referring to FIGS. 1 and 14, the display module 100 includes a cover plate 201 and a back film 203, and the display module 100 is based on a structure of color film on encapsulation (COE). That is, color film portions are directly formed on the encapsulation layer. A color film layer 205 is provided between the flexible display panel 10 and the cover plate 201. The color film layer 205 includes a separation pattern 2051 and a plurality of color film portions 2052, and the separation pattern 2051 is used for separating the plurality of color film portions 2052. The plurality of color film portions 2052 include red color film portions, green color film portions, and blue color film portions.

For example, a portion of the separation pattern 2051 in the region of the display surface other than the light-transmissive region Q is made of a black light absorbing material.

For example, a portion of the separation pattern 2051 in the light-transmissive region Q is made of a transparent material, which may help improve the light transmittance of the light-transmissive region Q, thereby meeting the shooting requirement of the under-screen camera.

For example, the display module 100 may further include an over coating (OC) layer 206, the OC layer 206 is disposed between the color film layer 205 and the cover plate 201 and covers the color film layer 205.

The display module 100 shown in FIG. 14 does not need to be provided with a polarizer, which is beneficial to reducing the cost of the display module 100. In addition, in the technology without a polarizer, the power consumption of a screen may be lower under the same display luminance, and a thickness of the screen can be greatly reduced, which is beneficial to prolonging the service life of the flexible display panel 10.

It will be noted that FIG. 14 is illustrated by considering an example in which the size of each color film portion 2052 is equal. In some other embodiments, sizes of color film portions 2052 of different colors may be different. For example, a size of the blue color film portion corresponds to a size of the blue light-emitting device, a size of the green color film portion corresponds to a size of the green light-emitting device, and a size of the red color film portion corresponds to a size of the red light-emitting device. In addition, a size of a color film portion 2052 in the light-transmissive region Q may be smaller than a size of a color film portion 2052 in the region of the display surface other than the light-transmissive region Q, and a density of color film portions 2052 in the light-transmissive region Q may be less than a density of color film portions 2052 in the region of the display surface other than the light-transmissive region Q.

FIG. 15 is a flow diagram of a method for manufacturing a display module provided in some embodiments of the present disclosure. In another aspect, referring to FIGS. 1, 2 and 15, some embodiments of the present disclosure provide the method for manufacturing the display module. The method includes S1 to S5.

In S1, a support plate 20 is provided, an opening design is performed in the support plate 20 to form a light-transmissive hole 21 in the support plate 20, the light-transmissive hole 21 penetrating the support plate 20. The light-transmissive hole 21 may be formed in the support plate by laser cutting, etching, or the like.

In S2, a transparent support structure 30 is filled in the light-transmissive hole 21.

In S3, a light-shielding portion 40 is filled between a sidewall 211 of the light-transmissive hole 21 and the transparent support structure 30.

In S4, a flexible display panel 10 is provided. The flexible display panel 10 includes a display surface 11, and the display surface 11 includes a light-transmissive region Q.

In S5, the flexible display panel 10 and the support plate 20 are bonded, and an orthographic projection of the transparent support structure 30 on the display surface 11 is ensured to at least partially overlap with the light-transmissive region Q, so that the display module 100 is formed.

In some embodiments, the transparent support structure 30 is filled in the light-transmissive hole 21, and the transparent support structure 30 may support the flexible display panel 10 together with the support plate 20, so as to reduce or eliminate the impression problem caused by the absence of force at the position of the light-transmissive hole 21. In addition, a transparent material is chosen to form the transparent support structure 30, so that the light transmittance requirement of the light-transmissive region Q may also be met. As a result, the imaging effect is improved. Moreover, the light-shielding portion 40 is disposed on at least part of the sidewall 211, and the light-shielding portion 40 may shield the light emitted by the light-emitting devices inside the flexible display panel 10, so as to prevent the light emitted by the light-emitting devices from entering an optical device, thereby avoiding the light leakage at the position of the light-transmissive hole 21 and improving the imaging quality of the optical device.

In some embodiments, referring to FIGS. 7 and 15, after step S3 is completed, a transparent protective layer 60 is spin-coated on a side of the support plate 20 facing away from the flexible display panel 10, so that a flat transparent protective layer 60 is formed. The transparent protective layer 60 is used to reduce or eliminate the impression problem of the display module 100.

In some embodiments, referring to FIGS. 9 and 15, after step S1 and before step S2, a transparent elastomer layer 80 is provided, and a first adhesive layer 71 and a second adhesive layer 72 are formed on an upper side and a lower side of the transparent elastomer layer 80, respectively. The transparent elastomer layer 80 is adhered to a first side of the support plate 20 by the first adhesive layer 71, and the first side of the support plate 20 is a side of the support plate 20 proximate to the flexible display panel 10 of the display module 100. Since the transparent elastomer layer 80 has a certain elasticity and a certain recovery performance, it may cushion a pressure during the support plate 20 and the flexible display panel 10 being attached and perform recovery after the attachment, thereby reducing the impression problem of the display module 100. In addition, since the light transmittance of the transparent elastomer layer 80 is greater than or equal to 95%, a material of the transparent elastomer layer belongs to a high-transmittance material, which may help improve the light transmittance and thus greatly improve the amount of the external light entering the light-transmissive region Q. As a result, the shooting effect and the face identification precision of the front camera are improved.

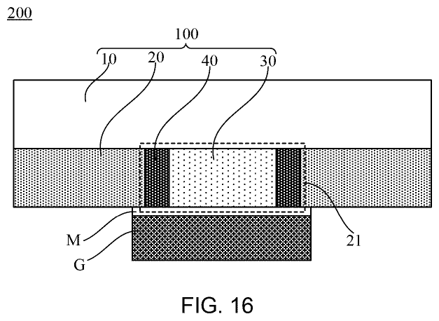

FIG. 16 is a sectional structural diagram of a display apparatus provided in some embodiments of the present disclosure. In another aspect, some embodiments of the present disclosure provide the display apparatus 200. Referring to FIG. 16, the display apparatus 200 includes the display module 100 according to any one of the above embodiments and optical device(s) G. The optical device(s) G are located at the side of the support plate 20 facing away from the flexible display panel 10, and an orthographic projection of an optical device G on the support plate 20 at least partially overlaps with the light-transmissive hole 21.

Since the support plate 20 includes the light-transmissive hole 21, and the orthographic projection of the optical device G on the support plate 20 at least partially overlaps with the light-transmissive hole 21, the light-transmissive hole 21 may meet the light transmittance requirement of the optical device G, so as to realize the full-screen design. The light-transmissive hole 21 is filled with the transparent support structure 30, and the orthographic projection of the transparent support structure 30 on the display surface 11 at least partially overlaps with the light-transmissive region Q; a transparent material is chosen for forming the transparent support structure 30, which may improve the relatively great influence of the transparent support structure 30 on the light transmittance at the position of the light-transmissive hole 21, so as to meet the light transmittance requirement of the optical device G, thereby improving the imaging effect. In addition, the transparent support structure 30 may be bonded to the support plate 20 and support the flexible display panel 10, which may reduce or eliminate the impression problem caused by the absence of force at the position of the light-transmissive hole 21. Moreover, the light-shielding portion 40 is disposed on the at least part of the sidewall 211 of the light-transmissive hole 21, and the light-shielding portion 40 may shield light emitted from the light-emitting devices inside the flexible display panel 10, thereby avoiding the light emitted from the light-emitting devices reaches the optical device G. As a result, it avoids the light leakage at the position of the light-transmissive hole 21 and thus improves the imaging quality of the optical device G.

For example, the optical device G may include a camera module, a fingerprint module, or a facial identification sensor. For example, the optical device G includes the camera module, and the camera module includes camera(s). By arranging the orthographic projection of the optical device G on the support plate 20 to at least partially overlap with the light-transmissive hole 21, it may be possible to help improve the camera shooting effect and the face identification precision of the front camera. The camera may be fixedly connected to the support plate 20 by a third adhesive layer M. A material of the third adhesive layer M is not limited in the embodiments of the present disclosure, as long as the material can fix the camera without affecting imaging of the camera.

For example, the display apparatus 200 provided in embodiments of the present disclosure may serve as any product or component having a display function such as a television, a mobile phone, a tablet computer, a notebook computer, a digital photo frame or a navigator. The use of the display apparatus 200 is not limited in the embodiments of the present disclosure.

In addition, the display apparatus 200 may be any apparatus that displays an image whether in motion (e.g., a video) or stationary (e.g., a still image), and whether literal or graphical. More specifically, it is anticipated that the embodiments may be implemented in or associated with a variety of electronic devices. The variety of electronic devices include (but not limit to), for example, mobile telephones, wireless devices, personal data assistants (PADs), hand-held or portable computers, global positioning system (GPS) receivers/navigators, cameras, MPEG-4 Part 14 (MP4) video players, video cameras, game consoles, watches, clocks, calculators, television monitors, flat panel displays, computer monitors, automobile displays (such as odometer displays), navigators, cockpit controllers and/or displays, camera view displays (e.g., rear view camera displays in a vehicle), electronic photos, electronic billboards or signages, projectors, architectural structures, packaging and aesthetic structures (e.g., displays for displaying an image of a piece of jewelry).

The foregoing descriptions are merely specific implementations of the present disclosure, but the protection scope of the present disclosure is not limited thereto. Any changes or replacements that a person skilled in the art could readily conceive of within the technical scope of the present disclosure shall be included in the protection scope of the present disclosure. Therefore, the protection scope of the present disclosure shall be subject to the protection scope of the claims.

1. A display module, comprising:
a flexible display panel including a display surface, the display surface including a light-transmissive region;
a support plate disposed on a side of the flexible display panel facing away from the display surface, the support plate having a light-transmissive hole;
a transparent support structure filled in the light-transmissive hole, an orthographic projection of the transparent support structure on the display surface at least partially overlaps with the light-transmissive region; and
a light-shielding portion disposed on at least part of a sidewall of the light-transmissive hole.

2. The display module according to claim 1, further comprising:
a reflection-reducing layer located in the light-transmissive hole, wherein the reflection-reducing layer and the transparent support structure are stacked.

3. The display module according to claim 2, wherein
the reflection-reducing layer is located on a side of the transparent support structure proximate to the flexible display panel.

4. The display module according to claim 2, wherein the reflection-reducing layer includes:
at least two first refractive layers; and
a second refractive layer located between two adjacent first refractive layers in the at least two first refractive layers;
wherein a refractive index of a first refractive layer in the at least two first refractive layers is less than a refractive index of the second refractive layer.

5. The display module according to claim 1, further comprising:
a transparent protective layer located on a side of the support plate facing away from the flexible display panel, wherein an orthographic projection of the transparent protective layer on the support plate covers the light-transmissive hole.

6. The display module according to claim 5, wherein
a minimum distance between a border of the orthographic projection of the transparent protective layer on the support plate and the light-transmissive hole is greater than or equal to 0.5 mm.

7. The display module according to claim 5, wherein
a modulus of the transparent protective layer is in a range of 8 MPa to 100 MPa, inclusive.

8. The display module according to claim 5, wherein
a thickness of the transparent protective layer gradually decreases from a center to an edge of the transparent protective layer.

9. The display module according to claim 5, wherein
a maximum thickness of the transparent protective layer is do, and do is greater than or equal to 20 μm and less than or equal to 50 μm (20 μm≤d0≤50 μm).

10. The display module according to claim 1, wherein
the support plate includes a first metal layer;
a thickness of the first metal layer is d1, and d1 is greater than or equal to 80 μm and less than or equal to 300 μm (80 μm≤ d1≤300 μm).

11. The display module according to claim 1, wherein
the support plate includes:
a second metal layer; and
an auxiliary support layer located on a side of the second metal layer proximate to the flexible display panel, wherein a unit weight of the auxiliary support layer is less than a unit weight of the second metal layer; a sum of a thickness of the second metal layer and a thickness of the auxiliary support layer is d2, and d2 is greater than or equal to 80 μm and less than or equal to 300 μm (80 μm≤ d2≤300 μm).

12. The display module according to claim 11, wherein
a material of the auxiliary support layer includes carbon fiber.

13. The display module according to claim 1, further comprising:
a first adhesive layer, a second adhesive layer, and a transparent elastomer layer that are stacked, wherein the transparent elastomer layer is located between the first adhesive layer and the second adhesive layer, and the first adhesive layer is located on a side of the transparent elastomer layer proximate to the support plate;
wherein a light transmittance of the transparent elastomer layer is greater than or equal to 95%.

14. The display module according to claim 13, wherein
an elastic modulus of the transparent elastomer layer is in a range of 40 MPa to 500 MPa, inclusive.

15. The display module according to claim 13, wherein
a material of the transparent elastomer layer includes at least one of a thermoplastic polyurethane elastomer, a thermoplastic elastomer or a thermoplastic polyester elastomer.

16. The display module according to claim 13, further comprising:
a light converging layer including a plurality of microlenses arranged at intervals, wherein the plurality of microlenses are located between the transparent elastomer layer and the first adhesive layer or between the transparent elastomer layer and the second adhesive layer;
an orthographic projection of the plurality of microlenses on the display surface at least partially overlaps with the orthographic projection of the transparent support structure on the display surface.

17. The display module according to claim 16, wherein the plurality of microlenses are located between the transparent elastomer layer and the second adhesive layer;
at least one of microlens in the plurality of microlenses includes a plurality of optical film layers that are stacked;
in two adjacent optical film layers, a refractive index of an optical film layer close to the support plate is less than a refractive index of an optical film layer away from the support plate; and
a refractive index of an optical film layer, closest to the support plate, in the plurality of optical film layers is greater than a refractive index of the transparent elastomer layer.

18. The display module according to claim 1, wherein
a material of the transparent support structure includes at least one of ultra-thin glass, polyethylene terephthalate, polymethyl methacrylate or polycarbonate; and/or
a dimension of the light-shielding portion in a direction directed from the transparent support structure to the support plate is d3, and d3 is greater than or equal to 0.1 mm and less than or equal to 1 mm (0.1 mm≤d3≤1 mm).

19. (canceled)

20. The display module according to claim 1, wherein
the support plate includes a first support portion, a second support portion and a bendable portion located between the first support portion and the second support portion, wherein the bendable portion has a plurality of grooves; and
there is at least one light-transmissive hole, the at least one light-transmissive hole is located in the first support portion and/or the second support portion.

21. A display apparatus, comprising:
the display module according to claim 1; and
an optical device located on a side of the support plate facing away from the flexible display panel, wherein an orthographic projection of the optical device on the support plate at least partially overlaps with the light-transmissive hole.
